(19) United States
(12) Patent Application Publication
(10) Pub. No.: US 2020/0096157 A1
(43) Pub. Date: Mar. 26, 2020

(54) LIQUID HYDROGEN FUELING SYSTEM INCLUDING LIQUID HYDROGEN STORAGE TANK AND FUELING METHOD THEREOF

(71) Applicant: Hylium Industries, Inc., Seongnam (KR)

(72) Inventors: Seo Young Kim, Yongin (KR); Se Cheol JANG, Osan (KR)

(73) Assignee: Hylium Industries, Inc., Seongnam (KR)

(21) Appl. No.: 16/226,189

(22) Filed: Dec. 19, 2018

(30) Foreign Application Priority Data
Sep. 20, 2018 (KR) 10-2018-0113196

(51) Int. Cl. F17C 5/02; F17C 1/12; F17C 13/00

(52) U.S. Cl. CPC F17C 5/02; F17C 1/12; F17C 13/002; F17C 2221/012; F17C 2223/0161; F17C 2225/0123; F17C 2203/0629; F17C 2260/02; F17C 2265/032; F17C 2201/0109; F17C 2201/032; F17C 2203/0391; F17C 2260/036

(57) ABSTRACT

Disclosed herein are a liquid hydrogen fueling system including a liquid hydrogen storage tank and a fueling method thereof. The liquid hydrogen fueling system partitions the inner tank of the liquid hydrogen storage tank into a first inner tank and a second inner tank, which are separate from each other, and makes liquid hydrogen easily flow from the liquid hydrogen storage tank to a high-pressure pump using the difference between the pressure inside the first inner tank and the pressure inside the second inner tank, thereby enabling high-pressure charging of liquid hydrogen in spite of the low density thereof.

### CROSS REFERENCE TO RELATED APPLICATION

This application claims the benefit of Korean Patent Application No. 10-2018-0113196, filed Sep. 20, 2018, which is hereby incorporated by reference in its entirety into this application.

### BACKGROUND OF THE INVENTION

### 1. Technical Field

The present invention relates generally to a liquid hydrogen fueling system including a liquid hydrogen storage tank and a fueling method thereof, and more particularly to a liquid hydrogen fueling system including a liquid hydrogen storage tank and a fueling method thereof whereby high-pressure charging of liquid hydrogen is possible in spite of the low density thereof and whereby liquid hydrogen may be supplied without evaporative loss of hydrogen in a high-pressure pump.

### 2. Description of the Related Art

Hydrogen is a fuel that is more than ten times lighter than fossil fuel, and is widely used as the fuel of vehicles such as rockets, unmanned aerial vehicles (UAVs), and the like in the aerospace field. With the commercialization of hydrogen fuel cell vehicles as clean, new-energy technology, hydrogen fueling stations for charging hydrogen fuel cell vehicles with hydrogen at high pressure have emerged as essential infrastructure.

In the conventional hydrogen fueling method, high-pressure hydrogen at a pressure of 100 atm is transported using a trailer on which a hydrogen tank is mounted, the transported hydrogen is temporarily stored after being pressurized up to 400 atm using a compressor in a hydrogen fueling station, and the temporarily stored hydrogen is pressurized again using the compressor in order to fuel a hydrogen fuel cell vehicle at a pressure of 700 atm.

FIG. 1 is a view that shows a liquid hydrogen fueling system according to the conventional art.

The conventional liquid hydrogen fueling system includes a liquid hydrogen storage tank 10, a high-pressure pump 20, a vaporizer 30, and a high-pressure hydrogen storage tank 40.

Liquid hydrogen stored in the liquid hydrogen storage tank 10 is supplied to the high-pressure pump 20 via a supply line L1 and is then pressurized by the high-pressure pump 20, whereby the liquid hydrogen reaches a supercritical state.

The liquid hydrogen pressurized by the high-pressure pump 20, which is in the supercritical state, is carried to the vaporizer 30, is transitioned to a gaseous state in the vaporizer 30, and is then stored in the high-pressure hydrogen storage tank 40.

The high-pressure hydrogen storage tank 40 for storing high-pressure gaseous hydrogen (H₂) may be multiple high-pressure vessels each having a suitable volume, and the hydrogen stored in the high-pressure hydrogen storage tank 40 may be supplied to an external target (not illustrated) to be charged, that is, may be used to charge the external target.

As described above, the hydrogen supplied from the liquid hydrogen storage tank 10 is forced to increase the pressure thereof in the high-pressure pump 20 and is supplied to the high-pressure hydrogen storage tank 40 via the vaporizer 30.

However, the very low density of liquid hydrogen, which is only 0.0708 relative to the density of water, impedes the inflow of liquid hydrogen from the liquid hydrogen storage tank 10 to the high-pressure pump 20, which makes high-pressure charging more difficult.

Also, when cryogenic liquid hydrogen is admitted into the cylinder of the high-pressure pump 20, cavitation, through which the cryogenic liquid hydrogen is vaporized due to a rise in temperature, may occur.

Here, cavitation may damage the pump itself, or may actually hinder cryogenic liquid hydrogen from being pumped from the liquid hydrogen storage tank 10,

As shown in FIG. 1, the conventional liquid hydrogen fueling system returns gaseous hydrogen, which is generated as the result of vaporization in the high-pressure pump 20, to the liquid hydrogen storage tank 10 via a return line L2.

However, when the gaseous hydrogen generated as the result of vaporization in the high-pressure pump 20 first flows in the liquid hydrogen storage tank 10, the gaseous hydrogen increases the pressure inside the tank.

When an increase in the pressure continues, a risk such as explosion or the like may be caused. Therefore, it is necessary to vent the gaseous hydrogen from the liquid hydrogen storage tank 10 in the interest of safety, but this may increase the loss of hydrogen, thereby needlessly wasting the same.

### SUMMARY OF THE INVENTION

The technical object of the present invention is to provide a liquid hydrogen fueling system that enables high-pressure charging of liquid hydrogen in spite of the low density of liquid hydrogen.

Another technical object of the present invention is to provide a liquid hydrogen fueling system that enables charging of liquid hydrogen without evaporative loss of hydrogen in a high-pressure pump.

In order to accomplish the above objects, the present invention provides a liquid hydrogen fueling system including a liquid hydrogen storage tank, which is in the form of a double-walled vessel including an inner tank and an outer tank. The liquid hydrogen fueling system may include a bulkhead for partitioning a space inside the inner tank; a first inner tank partitioned by the bulkhead; a second inner tank for storing cryogenic liquid hydrogen therein, the second inner tank being partitioned by the bulkhead so as to be separate from the first inner tank; a high-pressure pump for pressurizing the liquid hydrogen that is supplied from the second inner tank; a supply line for supplying the liquid hydrogen from the second inner tank to the high-pressure pump; and a return line for returning hydrogen gas, generated as a result of vaporization in the high-pressure pump, to the first inner tank, wherein the pressure inside the second inner tank may be higher than the pressure inside the first inner tank; and the liquid hydrogen may flow from the second inner tank to the high-pressure pump due to the difference between the pressure inside the first inner tank and the pressure inside the second inner tank.

The bulkhead may be in the form of a double-walled bulkhead, and a vacuum may be applied to the space between the walls of the double-walled bulkhead.

The bulkhead may have the shape of a convex curve, which is convex in the direction from the second inner tank to the first inner tank.

The first inner tank may be emptied out before supply of the liquid hydrogen from the second inner tank to the high-pressure pump is started.

The difference between the pressure inside the first inner tank and the pressure inside the second inner tank may be set equal to or greater than 2 bar before the supply of the liquid hydrogen from the second inner tank to the high-pressure pump is started.

The hydrogen gas that flows in the first inner tank via the return line may he re-liquefied due to adiabatic expansion.

The liquid hydrogen fueling system may further include a transport line for transporting liquid hydrogen, re-liquefied in the first inner tank, to the second inner tank.

The second inner tank may have a pressure-boosting device installed therein in order to regulate the pressure inside the second inner tank.

The pressure-boosting device may include a vaporizer for extracting the liquid hydrogen from the second inner tank and vaporizing the liquid hydrogen; and a regulator for regulating the pressure of hydrogen gas that is generated as a result of vaporization in the vaporizer, wherein the hydrogen gas, the pressure of which is regulated while passing through the vaporizer and the regulator, may he returned to the second inner tank.

Also, in order to accomplish the above objects, the present invention provides a fueling method of a liquid hydrogen fueling system including a liquid hydrogen storage tank, which is in the form of a double-walled vessel including an inner tank and an outer tank. The fueling method may include supplying liquid hydrogen from a second inner tank to a high-pressure pump and pressurizing the liquid hydrogen in the state in which a first inner tank is empty, the first inner tank and the second inner tank being separate from each other in such a way that a bulkhead installed in the inner tank partitions a space inside the inner tank into two spaces, which are the first inner tank and the second inner tank; completing supply of the liquid hydrogen from the second inner tank to the high-pressure pump; injecting liquid hydrogen into the first inner tank; supplying the liquid hydrogen from the first inner tank to the high-pressure pump and pressurizing the liquid hydrogen in the state in which the second inner tank is empty; and completing supply of the liquid hydrogen from the first inner tank to the high-pressure pump, wherein hydrogen gas generated as a result of vaporization in the high-pressure pump when the liquid hydrogen supplied from the second inner tank is pressurized may be returned to the first inner tank; and hydrogen gas generated as a result of vaporization in the high-pressure pump when the liquid hydrogen supplied from the first inner tank is pressurized may be returned to the second inner tank.

When the liquid hydrogen is supplied from the second inner tank to the high-pressure pump, the pressure inside the second inner tank may be higher than the pressure inside the first inner tank. When the liquid hydrogen is supplied from the first inner tank to the high-pressure pump, the pressure inside the first inner tank may be higher than the pressure inside the second inner tank. When the liquid hydrogen is supplied from the second inner tank to the high-pressure pump and when the liquid hydrogen is supplied from the first inner tank to the high-pressure pump, the liquid hydrogen may flow in the high-pressure pump due to the difference between the pressure inside the first inner tank and the pressure inside the second inner tank.

In the present invention, whenever one cycle of hydrogen charging is completed, the role of the first inner tank and the role of the second inner tank may be switched.

Also, in order to accomplish the above objects, the present invention provides a liquid hydrogen storage tank that is in the form of a double-walled vessel including an inner tank and an outer tank. The liquid hydrogen storage tank may include a bulkhead for partitioning a space inside the inner tank; a first inner tank partitioned by the bulkhead and arranged so as to be empty; a second inner tank for storing cryogenic liquid hydrogen, the second inner tank being separated from the first inner tank by the bulkhead; a supply line for supplying the liquid hydrogen from the second inner tank to a high-pressure pump; and a return line for returning hydrogen gas, generated as a result of vaporization in the high-pressure pump, to the first inner tank, wherein the bulkhead may be a double-walled bulkhead and a vacuum may be applied to the space between the walls of the double-walled bulkhead.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view that shows a liquid hydrogen fueling system according to a conventional art;

FIG. 2 is a view that shows a liquid hydrogen fueling system according to an embodiment of the present invention;

FIG. 3 is a view that shows a pressure-boosting device included in a liquid hydrogen fueling system according to the present invention; and

FIG. 4 is a view that shows a liquid hydrogen fueling system according to another embodiment of the present invention.

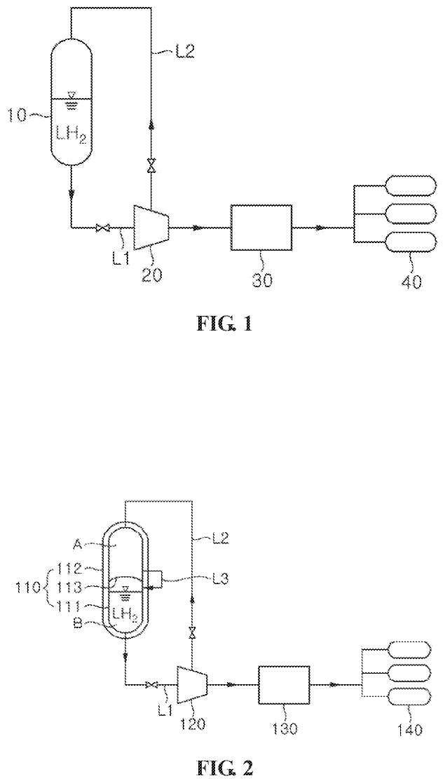

### DESCRIPTION OF THE PREFERRED EMBODIMENTS

In order to fully understand the present invention, the advantages in the operation of the present invention, and the objects accomplished by the implementations of the present invention, reference should be made to the accompanying drawings illustrating a preferred embodiment of the present invention and the content described therein.

Hereinafter, a preferred embodiment of the present invention will be described in detail with reference to the accompanying drawings. The same elements will be designated by the same reference numerals even when they are shown in different drawings.

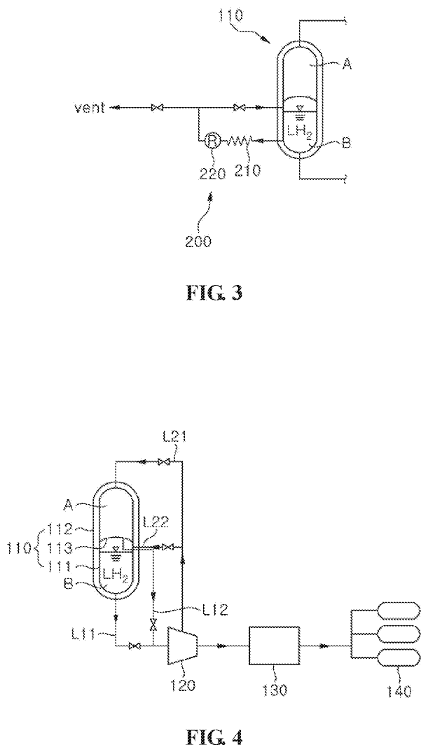

FIG. 2 is a view that shows a liquid hydrogen fueling system according to an embodiment of the present invention, and FIG. 3 is a view that shows a pressure-boosting device that is included in a liquid hydrogen fueling system according to the present invention.

Referring to FIG. 2, the liquid hydrogen fueling system according to an embodiment of the present invention includes a liquid hydrogen storage tank 110, in which cryogenic liquid hydrogen is stored, a high-pressure pump 120 for changing the liquid hydrogen supplied from the liquid hydrogen storage tank 110 to a supercritical state by pressurizing the same, a vaporizer 130 for vaporizing the liquid hydrogen pressurized by the high-pressure pump 120, and a high-pressure hydrogen storage tank 140 for storing hydrogen gas, which is generated through transition to a gaseous state in the vaporizer 130.

In the present embodiment, the liquid hydrogen storage tank 110 is in the form of a double-walled vessel including an inner tank 111 and an outer tank 112, and may be made of stainless steel.

The space between the inner tank 111 and the outer tank 112 may be filled with thermal insulation material in order to prevent heat transfer from the outside.

The high-pressure pump 120 provides pumping power in order to pump liquid hydrogen from the liquid hydrogen storage tank 110, in which hydrogen in a liquid form is stored, to the high-pressure hydrogen storage tank 140.

The liquid hydrogen, which is pressurized by the high-pressure pump 120 and is thus in the supercritical state, is carried to the vaporizer 130, is transitioned to a gaseous state, and is stored in the high-pressure hydrogen storage tank 140.

The high-pressure hydrogen storage tank 140 for storing high-pressure gaseous hydrogen may be multiple high-pressure vessels each having a suitable volume, and hydrogen gas may be distributed among the multiple separate storage spaces at the same pressure. The hydrogen stored in the high-pressure hydrogen storage tank 140 may be supplied to an external target to be charged (not illustrated), that is, may be used to charge the external target.

The high-pressure hydrogen storage tank 140 may also be a double-walled vessel with thermal insulation material that fills the space between the inner tank and the outer tank thereof, or may be a lightweight high-pressure tank mounted in a vehicle.

Meanwhile, as pointed out as the problem of the conventional art, because liquid hydrogen has a very low density, liquid hydrogen does not easily flow from the liquid hydrogen storage tank 110 to the high-pressure pump 120.

The present embodiment intends to solve the above problem by partitioning the space inside the inner tank 111 into two spaces by installing a bulkhead 113 therein.

As shown in FIG. 2, the inner tank 111 includes a first inner tank A and a second inner tank B, which are partitioned by the bulkhead 113.

The first inner tank A is set to be emptied out at the outset and to be connected with a return line L2, via which hydrogen gas generated as a result of vaporization in the high-pressure pump 120 is returned.

The second inner tank B stores cryogenic liquid hydrogen therein, and the pressure inside the second inner tank B is higher than the pressure inside the first inner tank A. The second inner tank B is connected with the high-pressure pump 120 via a supply line L1.

When the inner tank 111 is configured as described above, because the pressure inside the second inner tank B, which is filled with liquid hydrogen, is higher than the pressure inside the first inner tank A, which is empty, the liquid hydrogen may easily flow from the second inner tank B to the high-pressure pump 120 due to the difference between the pressure inside the second inner tank B and the pressure inside the first inner tank A.

In a preferred example of the present embodiment, the pressure inside the first inner tank A and the pressure inside the second inner tank B may be initially set to 1 bar and 8 bar, respectively, and it is desirable for the initial difference therebetween to be set equal to or greater than 2 bar before charging of hydrogen is started. Also, it is desirable for the initial difference not to exceed 20 bar, and more desirably, the initial difference may be set equal to or less than 10 bar.

The bulkhead 113 installed inside the inner tank 111 may have the shape of a convex curve, which is convex in the direction from the second inner tank B to the first inner tank A in order to withstand the pressure inside the second inner tank B.

Also, the bulkhead 113 may be a double-walled bulkhead in order to prevent heat transfer between the first inner tank A and the second inner tank B. More desirably, the bulkhead 113 may be a pair of bulkheads that are spaced 10 mm or more apart from each other, and a vacuum may be applied to the space between the bulkheads.

Here, the bulkhead 113, configured as a double-walled bulkhead, serves to prevent liquid hydrogen stored in the second inner tank B from being vaporized due to heat transferred from the first inner tank A.

The present embodiment may further include a pressure-boosting device 200 that is installed in the second inner tank B in order to regulate the pressure inside the second inner tank B.

Even though initial settings are configured to create a difference between the pressure inside the first inner tank A and the pressure inside the second inner tank B, because the pressure inside the second inner tank B gradually decreases during the charging of hydrogen, the pressure-boosting device 200 is used to regulate the pressure inside the second inner tank B such that the pressure inside the second inner tank B is maintained higher than the pressure inside the first inner tank A.

The pressure-boosting device 200, shown in FIG. 3, includes a vaporizer 210 for extracting liquid hydrogen from the second inner tank B and vaporizing the same and a regulator 220 for regulating pressure.

The pressure-boosting device 200 vaporizes the liquid hydrogen extracted from the second inner tank B, regulates the pressure of the vaporized hydrogen, and returns the vaporized hydrogen to the second inner tank B, thereby increasing the pressure inside the second inner tank B.

Upon commencement of hydrogen charging, the liquid hydrogen stored in the second inner tank B is supplied to the high-pressure hydrogen storage tank 140 via the high-pressure pump 120 and the vaporizer 130. In this process, hydrogen gas generated as the result of vaporization in the high-pressure pump 120 is returned to the first inner tank A.

Here, the hydrogen gas returned to the first inner tank A may be re-liquefied by a temperature drop due to adiabatic expansion. The liquid hydrogen re-liquefied in the first inner tank A may be transported to the second inner tank B in order to reuse the same, and a transport line L3 for transporting the re-liquefied liquid hydrogen may be disposed between the first inner tank A and the second inner tank B.

The liquid hydrogen fueling system according to the present embodiment partitions the inner tank 111 of the liquid hydrogen storage tank 110 into the first inner tank A and the second inner tank B, which are separate from each other, and makes liquid hydrogen easily flow from the liquid hydrogen storage tank 110 to the high-pressure pump 120 using the difference between the pressure inside the first inner tank A and the pressure inside the second inner tank B, thereby enabling high-pressure charging of liquid hydrogen in spite of the low density thereof.

Also, because the present invention returns hydrogen gas, generated as the result of vaporization in the high-pressure pump 120, to the empty first inner tank A, there is no need to unnecessarily vent the hydrogen gas from a tank for fear of a rise in the pressure in the tank, as in the conventional method. Therefore, there is an effect of enabling charging of liquid hydrogen without evaporative loss of hydrogen in the high-pressure pump 120.

FIG. 4 is a view that shows a liquid hydrogen fueling system according to another embodiment of the present invention.

In the liquid hydrogen fueling system according to the embodiment shown in FIG. 2, with a decrease in the amount of liquid hydrogen stored in the second inner tank B, the pressure inside the second inner tank B is gradually decreased. Also, with the inflow of vaporized hydrogen into the first inner tank A, the pressure inside the first inner tank A is somewhat increased. Accordingly, upon completion of hydrogen charging, the difference between the pressure inside the first inner tank A and the pressure inside the second inner tank B may be reversed.

The liquid hydrogen fueling system according to another embodiment shown in FIG. 4 proposes a method in which the roles of the first inner tank A and the second inner tank B are switched when one cycle of hydrogen charging is finished and the next charging cycle is performed.

Referring to FIG. 4, the liquid hydrogen fueling system according to another embodiment of the present invention may further include a first supply line L11 for supplying liquid hydrogen from the second inner tank B to the high-pressure pump 120, a second supply line L12 for supplying liquid hydrogen from the first inner tank A to the high-pressure pump 120, a first return line L21 for returning hydrogen gas, generated as a result of vaporization in the high-pressure pump 120, to the first inner tank A, and a second return line L22 for returning hydrogen gas, generated as a result of vaporization in the high-pressure pump 120, to the second inner tank B.

In the present embodiment, when hydrogen charging is first performed by the liquid hydrogen fueling system, the liquid hydrogen stored in the second inner tank B is supplied to the high-pressure pump 120 via the first supply line L11 in the state in which the first inner tank A is emptied out, similar to the embodiment shown in FIG. 2. The hydrogen gas generated as a result of vaporization in the high-pressure pump 120 is returned to the first inner tank A via the first return line L21 and is then re-liquefied.

Here, thanks to the difference between the pressure inside the first inner tank A and the pressure inside the second inner tank B, liquid hydrogen may be easily supplied from the second inner tank B to the high-pressure pump 120.

When the supply of liquid hydrogen from the second inner tank B to the high-pressure pump 120 is finished, a small amount of re-liquefied liquid hydrogen is stored in the first inner tank A. In the present embodiment, rather than extracting the re-liquefied liquid hydrogen or transporting the same to the second inner tank B, the first inner tank A is filled with more liquid hydrogen.

Accordingly, the liquid hydrogen to be supplied to the high-pressure hydrogen storage tank 140 is stored in the first inner tank A, and the second inner tank B is emptied, that is, the state is the reverse of the state before the first cycle of hydrogen charging was started.

When the next cycle of hydrogen charging is performed, the liquid hydrogen stored in the first inner tank A is supplied to the high-pressure pump 120 via the second supply line L12 in the state in which the second inner tank B is empty. The hydrogen gas generated as a result of vaporization in the high-pressure pump 120 is returned to the second inner tank B via the second return line L22 and is then re-liquefied.

Additionally, at this time, thanks to the difference between the pressure inside the first inner tank A and the pressure inside the second inner tank B, liquid hydrogen may be easily supplied from the first inner tank A to the high-pressure pump 120.

When the supply of liquid hydrogen from the first inner tank A to the high-pressure pump 120 is finished, the operation is repeated in order to switch the roles of the first inner tank A and the second inner tank B, whereby liquid hydrogen may be supplied from the second inner tank B to the high-pressure pump 120.

As described above, the roles of the first inner tank A and the second inner tank B are switched whenever one hydrogen charging cycle is completed, whereby charging of hydrogen may be performed.

According to the present embodiment, it may be necessary to regulate both the pressure inside the first inner tank A and the pressure inside the second inner tank B. Therefore, the pressure-boosting device 200 shown in FIG. 3 may be configured to regulate both the pressure inside the first inner tank A and the pressure inside the second inner tank B.

Also, in the present embodiment, cryogenic liquid hydrogen may also be stored in the first inner tank A. Therefore, it is essential that the bulkhead 113 that comes into contact with the cryogenic liquid hydrogen be a double-walled bulkhead.

The liquid hydrogen fueling system according to the present invention has effects of enabling high-pressure charging of liquid hydrogen in spite of the low density of liquid hydrogen and of enabling charging of liquid hydrogen without evaporative loss of hydrogen in a high-pressure pump.

The present invention is not limited to the above-described embodiments. Those skilled in the art will appreciate that various modifications and other equivalent embodiments are possible, without departing from the scope and spirit of the invention. Therefore, the entire scope of the appended claims and their equivalents should be understood as defining the scope and spirit of the present invention.

What is claimed is:

1. A liquid hydrogen fueling system including a liquid hydrogen storage tank, which is in a form of a double-walled vessel including an inner tank and an outer tank, comprising:
a bulkhead for partitioning a space inside the inner tank;
a first inner tank partitioned by the bulkhead;
a second inner tank for storing cryogenic liquid hydrogen therein, the second inner tank being partitioned by the bulkhead so as to be separate from the first inner tank;
a high-pressure pump for pressurizing the liquid hydrogen that is supplied from the second inner tank;
a supply line for supplying the liquid hydrogen from the second inner tank to the high-pressure pump; and
a return line for returning hydrogen gas, generated as a result of vaporization in the high-pressure pump, to the first inner tank,
wherein:
a pressure inside the second inner tank is higher than a pressure inside the first inner tank; and
the liquid hydrogen flows from the second inner tank to the high-pressure pump due to a difference between the pressure inside the first inner tank and the pressure inside the second inner tank.

2. The liquid hydrogen fueling system of claim 1, wherein the bulkhead is in a form of a double-walled bulkhead, and a vacuum is applied to a space between walls of the double-walled bulkhead.

3. The liquid hydrogen fueling system of claim 2, wherein the bulkhead has a shape of a convex curve, which is convex in a direction from the second inner tank to the first inner tank.

4. The liquid hydrogen fueling system of claim 1, wherein the first inner tank is emptied out before supply of the liquid hydrogen from the second inner tank to the high-pressure pump is started.

5. The liquid hydrogen fueling system of claim 4, wherein the difference between the pressure inside the first inner tank and the pressure inside the second inner tank is set equal to or greater than 2 bar before the supply of the liquid hydrogen from the second inner tank to the high-pressure pump is started.

6. The liquid hydrogen fueling system of claim 4, wherein the hydrogen gas that flows in the first inner tank via the return line is re-liquefied due to adiabatic expansion.

7. The liquid hydrogen fueling system of claim 6, further comprising:
a transport line for transporting liquid hydrogen, re-liquefied in the first inner tank, to the second inner tank.

8. The liquid hydrogen fueling system of claim 4, wherein the second inner tank has a pressure-boosting device installed therein in order to regulate the pressure inside the second inner tank.

9. The liquid hydrogen fueling system of claim 8. wherein the pressure-boosting device comprises:
a vaporizer for extracting the liquid hydrogen from the second inner tank and vaporizing the liquid hydrogen; and
a regulator for regulating a pressure of hydrogen gas that is generated as a result of vaporization in the vaporizer,
wherein the hydrogen gas, the pressure of which is regulated while passing through the vaporizer and the regulator, is returned to the second inner tank.

10. A fueling method of a liquid hydrogen fueling system including a liquid hydrogen storage tank, which is in a form of a double-walled vessel including an inner tank and an outer tank, the fueling method comprising:
supplying liquid hydrogen front a second inner tank to a high-pressure pump and pressurizing the liquid hydrogen in a state in which a first inner tank is empty, the first inner tank and the second inner tank being separate from each other in such a way that a bulkhead installed in the inner tank partitions a space inside the inner tank into two spaces, which are the first inner tank and the second inner tank;
completing supply of the liquid hydrogen from the second inner tank to the high-pressure pump;
injecting liquid hydrogen into the first inner tank;
supplying the liquid hydrogen from the first inner tank to the high-pressure pump and pressurizing the liquid hydrogen in a state in which the second inner tank is empty; and
completing supply of the liquid hydrogen from the first inner tank to the high-pressure pump,
wherein:
hydrogen gas generated as a result of vaporization in the high-pressure pump when the liquid hydrogen supplied from the second inner tank is pressurized is returned to the first inner tank; and
hydrogen gas generated as a result of vaporization in the high-pressure pump when the liquid hydrogen supplied from the first inner tank is pressurized is returned to the second inner tank.

11. The fueling method of claim 10, wherein:
when the liquid hydrogen is supplied from the second inner tank to the high-pressure pump, a pressure inside the second inner tank is higher than a pressure inside the first inner tank,
when the liquid hydrogen is supplied from the first inner tank to the high-pressure pump, the pressure inside the first inner tank is higher than the pressure inside the second inner tank, and
when the liquid hydrogen is supplied from the second inner tank to the high-pressure pump and when the liquid hydrogen is supplied from the first inner tank to the high-pressure pump, the liquid hydrogen flows in the high-pressure pump due to a difference between the pressure inside the first inner tank and the pressure inside the second inner tank.

12. The fueling method of claim 10, wherein, whenever one cycle of hydrogen charging is completed, a role of the first inner tank and a role of the second inner tank are switched.

13. A liquid hydrogen storage tank that is in a form of a double-walled vessel including an inner tank and an outer tank, comprising:
a bulkhead for partitioning a space inside the inner tank;
a first inner tank partitioned by the bulkhead and arranged so as to be empty;
a second inner tank for storing cryogenic liquid hydrogen, the second inner tank being separated from the first inner tank by the bulkhead;
a supply line for supplying the liquid hydrogen from the second inner tank to a high-pressure pump; and
a return line for returning hydrogen gas, generated as a result of vaporization in the high-pressure pump, to the first inner tank,
wherein the bulkhead is a double-walled bulkhead and a vacuum is applied to a space between walls of the double-walled bulkhead.
